(19) United States
(12) Patent Application Publication
(10) Pub. No.: US 2021/0150468 A1
(43) Pub. Date: May 20, 2021

(54) MANAGEMENT OF ITEM ATTRIBUTE DATA FOR SHIPPING AND HANDLING SYSTEMS

(71) Applicant: Target Brands, Inc., Minneapolis, MN (US)

(72) Inventors: Adam Charles Wright, Minneapolis, MN (US); Mark Steven Siebenaller, Minneapolis, MN (US); Thomas Alan Mitchell, Apple Valley, MN (US); Deepa Sarasamma, Plymouth, MN (US); David Michael Stephens, St. Michael, MN (US); Mohanraj Subramaniam, Hopkins, MN (US); Laura Anne Herzog, Hudson, WI (US); Michael Warren Weum, Woodbury, MN (US); Gurupandi Ponnaiah, Minnetonka, MN (US); Pavan Kumar Bajaj, Minneapolis, MN (US); Suresh Gogineni, North Grafton, MA (US); Allen Sajjith Arulsamy Nayagam, Hopkins, MN (US); Sundar Puthur Gomathinayagam, Chennai (IN); Sara Steinberger, Minneapolis, MN (US)

(21) Appl. No.: 16/687,064

(22) Filed: Nov. 18, 2019

(51) Int. Cl. G06Q 10/08; G06F 16/23

(52) U.S. Cl. CPC G06Q 10/0832; G06F 16/2379; G06F 3/0482; G06Q 10/0838; G06Q 10/087

(57) ABSTRACT

Methods and systems for managing attribute data for shipping and handling within a retail supply chain are disclosed. Item attributes of new items are recorded upon first receipt at a distribution center and are stored in a local database. This attribute data is synchronized to a centralized database. Data from the centralized database is pushed out to other distribution centers. The use of a centralized database of item attributes streamlines the process of inputting data for new items. This database is accessible by multiple systems with the supply chain to determine how the items should be processed. A pathfinding system utilizes item attribute data and facility data to determine a processing route for each item passing through a distribution facility.

### TECHNICAL FIELD

The present disclosure relates generally to methods and systems for managing item attribute data for shipping and handling. More particularly, the present disclosure describes a streamlined data intake process that results in a centralized repository of item attribute data that can be used by multiple systems within a supply chain.

### BACKGROUND

In modern supply chains, computerized systems are relied upon to manage shipping and handling of items. These systems draw upon various sources of data to perform their calculations. Data regarding attributes of the items that are moving through the supply chain are essential to make various decisions about how items are processed. Some decisions must be made shortly after an item arrives at a distribution facility. Therefore, it would be beneficial to have access to item attribute data as soon as possible after receiving an item.

### SUMMARY

In summary, the present disclosure relates to methods and systems for managing attribute data for shipping and handling within a retail supply chain. A centralized database of item attributes streamlines the process of inputting data for new items. This database is accessible by multiple systems with the supply chain to determine how the items should be processed. A pathfinding system utilizes item attribute data and facility data to determine a processing route for each item passing through a distribution facility. Various aspects are described in this disclosure, which include, but are not limited to, the following aspects.

In one aspect, a method of managing item handling within a retail enterprise supply chain including a plurality of distribution facilities is described. Attributes of a first item are captured at a first distribution facility and the attributes of the first item are communicated to a centralized item attribute database for storage. A first set of routing information is generated for the first item and first distribution facility based on the attributes of the first item and facility attributes of the first distribution facility. In some embodiments, a second set of routing information can be generated for the first item and a second distribution facility. The second distribution facility has different facility attributes than the first distribution facility. In some embodiments, a second set of routing information can be generated based on the receipt of the first item at a second distribution facility without requiring capture of item attributes for the first item and the second distribution location.

In another aspect, a system is described for managing handling of items within a retail enterprise supply chain including a plurality of distribution facilities. The system includes a centralized item attribute database for the retail enterprise supply chain; a plurality of local item attribute databases at each of the plurality of distribution facilities; and a facility attribute database comprising facility attribute data for the plurality of distribution facilities. The system also includes an item attribute management system and an item handling pathfinder. The item attribute management system comprises a processing device and a memory device comprising instructions that, when executed by the processing device, cause the item attribute management system to: receive input of an item identifiers associated with items at a first distribution facility; receive item attribute data for the items; store the item attribute data in a local database at the first distribution facility; retrieve the item attribute data from the local database; insert the item attribute data into a landing table of a centralized item attribute database; update a master table of the centralized item attribute database with the item attribute data from the landing table; communicate the item attribute data stored in the master table from the centralized item attribute database to an update communicator; retrieve the item attribute data from update communicator; and store the item attribute data in a local item attribute database at a second distribution facility. The item handling pathfinder comprises a processing device and a memory device comprising instructions that, when executed by the processing device, cause the item handling pathfinder to: access item attribute data for a first item; determine handling requirements for the first item; access facility attributes of the first distribution facility; analyze the item attributes of the first item and the facility attributes of the first distribution facility to determine a first set of routing information; and output the first set of routing information to a computing device at the first distribution facility. In some embodiments, the item attribute management system further includes a graphical user interface configured to display fields on a computing device for receiving input of item attribute data. In some embodiments, the item attribute management system includes an application programming interface in communication with the master table of the centralized item attribute database. The application programming interface provides item attribute data to external computing services within the retail enterprise supply chain.

In yet another aspect, a non-transitory computer-readable storage medium comprising computer-executable instructions is disclosed which, when executed by a computing system, cause the computing system to perform a method of managing item attribute data. Attributes of a first item at a first distribution facility are captured by: receiving input of item identifier; ascertaining that first item is being received for the first time in the retail enterprise supply chain; creating a new item record for the first item; receiving input of item attributes for the first item; and storing the item attributes for the first item in a local database at the first distribution facility. The attributes of the first item are communicated to a centralized item attribute database for storage by: searching local item attribute databases for item records that have been modified; inserting updated item attribute data into landing table of centralized item attribute database; updating master table of centralized item attribute database with item attribute data from landing table; recording data updating activity in an activity tracking data within the centralized item attribute database; and optionally archiving information from the landing table to an archive table within the centralized item attribute database after 7 days. Item attribute data is communicated for the first item to a second distribution facility by: communicating the item attribute data stored in the master table for the first item from the centralized item attribute database to an update communicator; checking the update communicator for updates to item attribute data; retrieving updated item attribute data including item attribute data for the first item from update communicator; and storing the attribute data for the first item in the local item attribute database at the second distribution facility. A first set of routing information is generated for the first item and first distribution facility by: accessing the item attributes of the first item; determining handling requirements for the first item based on the item attributes; accessing facility attributes of the first distribution location; analyzing the item attributes of the first item and the facility attributes of the first distribution facility to determine the first set of routing information; and outputting the first set of routing information to a computing device. A second set of routing information is generated for the first item and second distribution facility by: accessing the handling requirements for the first item; accessing facility attributes of the second distribution facility; analyzing the item attributes of the first item and the facility attributes of the second distribution facility to determine the second set of routing information; and outputting the second set of routing information to a computing device. In some embodiments, the second set of routing information is generated upon receipt of the first item at the second distribution facility and does not require capturing attributes of the first item at the second distribution facility.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

FIG. 1 illustrates a schematic diagram of an example facility for processing and distributing items received from vendors.

FIG. 2 illustrates a schematic diagram of an item attribute management system.

FIG. 3 illustrates a schematic diagram of the item handling pathfinder of FIG. 1.

FIG. 4 illustrates an example block diagram of a computing system usable in the supply chain management system of FIG. 1.

FIG. 5 is a flow diagram of an example method of managing handling of items within a retail supply chain.

FIG. 6 is flow diagram of an example method of recording item attributes in a local database.

FIG. 7 is a flow diagram of an example method of synchronizing item attribute data from a local database to a centralized item attribute database.

FIG. 8 is a flow diagram of an example method of synchronizing item attribute data from a centralized item attribute database to one or more local databases located at other distribution facilities.

FIG. 9 is a flow diagram illustrating a method of determining a handling path through a distribution facility.

FIG. 10 illustrates an example application of the item attribute management system of FIG. 2 in two different facilities.

FIG. 11 illustrates an example graphical user interface.

FIG. 12 illustrates another view of the graphical user interface of FIG. 11.

FIG. 13 illustrates another view of the graphical user interface of FIG. 11.

FIG. 14 illustrates another view of the graphical user interface of FIG. 11.

FIG. 15 illustrates another view of the graphical user interface of FIG. 11.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

An improved system and method of recording and storing item characteristics data for inventory items is provided. As a new item is received into inventory at a distribution center, it's dimensions, weight, and other characteristics are recorded and input into a computing system. In some instances, the dimensions and weight can be measured with a dimensioner device such as CUBISCAN to automate part of this process. Other characteristics of the items can be supplied by the vendor. This prepopulates forms within warehouse management system software. Important characteristics are those relevant to storage and cartonization of items such as whether they are food, whether they are conveyable, and the type of container they are in. Other attributes may be used for planogram systems, inventory systems, and other computing systems within the retail enterprise.

An improved user interface is provided that makes inputting item characteristics simpler and faster for employees. In addition to prepopulating the existing information, many fields are presented as drop down menus allowing for selection from a finite list of options rather than freeform text fields. Once this information is recorded for an item in the local database for that distribution facility, it is communicated to a centralized database. The action of collecting any item attribute changes initiated from a user and storing within the local landing table is accomplished with a shell script which executes a local SQL stored procedure that runs every 15 minutes. Then a producer application, utilizing a messenger service such as Apache Camel, is used to send data from the distribution center databases to populate (inserts or updates) the centralized database, in this case a spring boot application framework written in groovy. This same application then creates a message within the a queue, such as a Kafka topic, to inform the consuming applications that a change has been made on an item.

From there, the consumer application will consume the new message off the queue, and performs two calls to (application programming interface) APIs. The first of which is to an external host application responsible for item to facility relationships. This ensures that item attributes are sent only facilities that should have this item. Secondly, the consumer application will call an API to then consume the new item attributes from the centralized database. This architecture allows easy scalability for any number of consumers or facilities and allows for external computing services within the retail supply chain to access item attribute data if desired. This is accomplished once again with a spring boot application framework written in groovy.

The system also includes a feature where it can send item attributes for any new legal facility. Essentially, this feature will identify any newly created items within the warehouse management system, populated from host application feeds, then send the existing item attributes within the centralized database if the item has been first receipted already. This is accomplished as well via a shell script executing a local SQL stored procedure as well as the same producer application will mark a status on the centralized database so that the following run from the consumer application will include this new item, and thus send to the new facility. Ultimately, this improved system, including this feature and method allow for new item characteristics to be recorded only once, and then the item information is shared with other distribution facilities. This reduces redundant data acquisition efforts, thus reducing labor costs.

The present disclosure describes a tool and user interface that adds and edits supply chain attributes associated with each item, case, or pack handled by a retail enterprise. When a particular item shipment is received, certain data attributes might be received as well, but additional information is needed to determine the retailer's handling systems can best process those items. For example, an item handling pathfinder needs to know whether the item is “squishable,” nestable, or requires particular storage conditions. Additional attributes can be added as well (e.g. is the item eachable, can the item ship in its own package, too shiny to read a bar code, able to pass through certain custom sorting solutions). The item handling pathfinder has an output of a yes/no decision as to whether a product is eachable as well as suggestions regarding packaging (e.g., bubble wrap, box needed, etc.). This information is used to determine a defined process path for the item through the distribution center. This path can be communicated to computing systems that control movement of items, such as automated systems within a warehouse or distribution facility.

Overall, the decision-making in the pathfinder is based on enhanced data that is added to item information at the time of item receipt. The item handling pathfinder will output packaging/handling guidelines as well as eachability decisions that can be used for routing items within a distribution facility more efficiently.

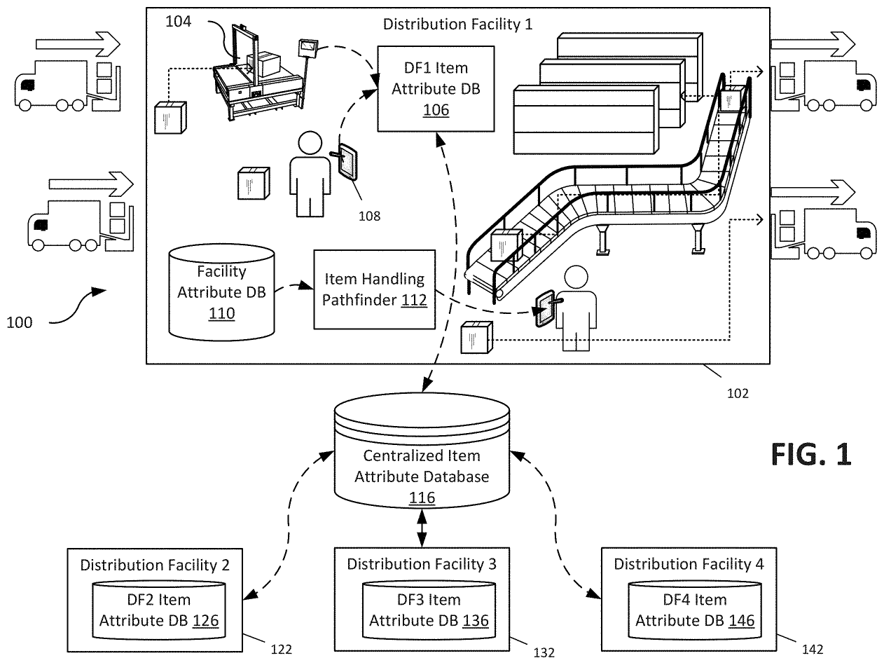

FIG. 1 illustrates a schematic diagram 100 of an example facility for processing and distributing items from receipt to ship. The diagram 100 illustrates the flow of items I through a first distribution facility 102. Attribute data for those items I is captured and stored in a centralized item attribute database 116 for use by other distribution facilities 122, 132, 142 and the item handling pathfinder 112.

Items I arrive at the first distribution facility 102 from vendors or other nodes within a retail supply chain. Nodes can include distribution centers, flow centers, warehouses, stockrooms, and retail stores. Attributes of the items I are recorded by one or both of an automated attribute measurement device 104 and a user computing device 108. Various attributes of the items are recorded such as dimensions, weight, color, material, whether the item needs special handling, and whether the item needs special storage conditions. The item attribute data is initially updated locally in an item attributes database 106 at the first distribution facility 102. In some embodiments, the item attributes database 106 is part of the same database that stores facility attributes. Through a stored procedure, the item attribute data is synchronized with a centralized item attribute database 116 that can be sent via a consumer application to update other distribution centers and other systems within the retail supply chain. The centralized item attribute database 116 provides the benefit of keeping item attribute information organized by item identifier (such as SKU) so that when items arrive at a distribution facility that have already been processed to obtain item attribute data, those items will not need to be processed at other distribution facilities.

In some embodiments, database links are used to directly communicate item attributes between local databases at each facility and thus a centralized master database is not required. However, this model lacks many additional features such as the decision making of item legalization, the capability of automatically obtaining item characteristics for new items from a known source, and a Kafka topic allowing any source to consume the item characteristic updates.

Examples of item attributes that may be recorded in the databases for the items include UPCs, TCINs, unit length, unit width, unit height, unit weight, unit volume, casepack length, casepack width, casepack height, casepack weight, casepack volume, whether an expiration data is required, whether a consume priority calculation is required, level of grouping for consume priority calculation, gift wrap eligibility, gift wrap type, oLPN type, critical dimensions of item, whether item ships in its own container, fragility, first receipt flag, prep code, food flap, and warehouse prep code. Other attributes are possible.

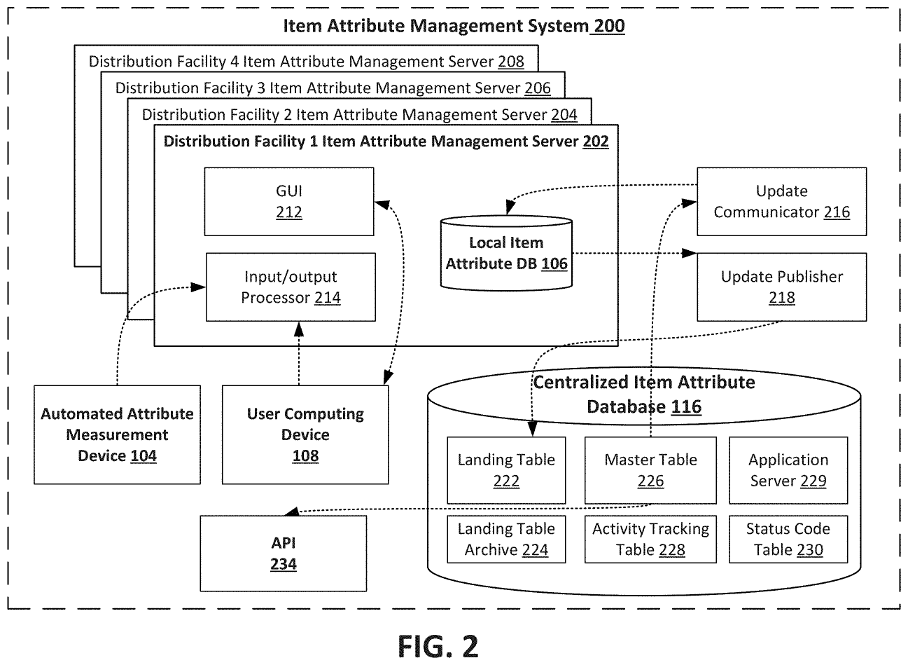

FIG. 2 illustrates a schematic diagram of an example item attribute management system 200. Components of the item attribute management system 200 can include one or more distribution facility item attribute management servers 202, 204, 206, 208, a centralized item attribute database 116, an automated attribute measurement device 104, and a user computing device 108. The item attribute management server 202 facilitates the gathering and distribution of item attribute information for items that arrive at a distribution center. Any new or updated attribute information is recorded in a centralized item attribute database 116 so that it is accessible by other systems and distribution facilities.

In some embodiments, automated attribute measurement devices 104 and user computing devices 108 are utilized to capture item attributes for recordation in attribute data stores. The automated attribute measurement devices 104 can be dimensioner devices, such as those manufactured by CUBISCAN, that are in communication with a computing device. These devices can quickly measure an item's dimensions and weight. Additional item attributes can be recorded on a user computing device 108 by an employee in the distribution facility. Some item attributes can be obtained directly from a vendor that is supplying the items. Data can be added or edited by an employee using a streamlined graphical user interface (GUI) to input needed data simply and quickly.

In the embodiment of FIG. 2, the Distribution Facility 1 item attribute management server 202 includes a local item attribute database 106, a user interface 212, and an input/output processor 214. The item attribute management servers 204, 206, 208 of other distribution facilities can include the same components. In some embodiments, one update communicator 216 and one update publisher 218 are utilized by all item attribute management servers. In some embodiments, the update communicator 216 and update publisher 218 could be part of the Distribution Facility 1 item attribute management server 202 and each item attribute management server 204, 206, 208 for the other distribution facilities could also have their own update communicator 216 and update publisher 218.

An automatic dimensioning machine can be used to accurately capture item dimensions and weight. The dimensions generally include length, width, and height for each item. Each item is a parcel or general unit that will be processed for later shipments. In some instances, the item is a product that is not packaged in any way. Some items are products that are packaged and ready to be sent to a consumer or displayed on a shelf for purchase. In some instances, the item could be a package consisting of multiple units of a particular product. In some embodiments, dimensions are manually measured and entered by an employee.

In addition to getting the item dimensions, other attributes that are needed for processing the item throughout the supply chain are recorded. These additional attributes are recorded by an employee using a computing device. In some embodiments, a graphical user interface designed to facilitate the gathering of such attribute information is displayed on the computing device and receives input from the employee. In some embodiments, the user interface is optimized to obtain the needed attribute information while requiring the least possible effort from the employee. The user interface can use conditional logic to minimize user input errors and improve data quality.

The local item attribute database 106 stores attribute data for items that have passed through a distribution facility. The local item attribute database 106 stores tables of information that are organized by item identifier. For example, SKU's or TCINs can be used to access item information for an item that comes into a distribution center. Scanning a barcode or RFID tag could access the item's identifier to pull up the item attributes. Item attributes can include dimensions, weights, the materials the item is made of, the color of the item, the category of item, eachability, stackability, squishability, expiration date, what types of equipment can handle the item (e.g. conveyors, etc.), whether the item needs special handling, how fragile the item is, what temperature the item needs to be stored at, and whether an item can be gift wrapped. Different systems may access the item data through an API 234 for different purposes and will find different attributes to be of use while others are disregarded.

The graphical user interface (GUI) 212 is interacted with via a user computing device 108. In some embodiments, the GUI 212 presents a simplified screen that includes selectors for various item attribute data. Available selections are limited to options available within a retail supply chain. In some instances, some fields will only be displayed if certain data is input. In some embodiments, the GUI 212 is designed to be compatible with third party warehouse management systems.

Prompts can be displayed on the GUI 212 to simply the data input process. In some embodiments, a user can view the GUI 212 to determine whether an existing item record needs to be updated or supplemented with new item attribute data. In some embodiments, input received through the GUI 212 is used to update existing records after receiving a prompt to edit item attribute data. Attribute information received through the user interface 212 is communicated to the input/output processor 214.

The input/output processor 214 receives information from one or both of the automated attribute measurement device 104 and the user computing device 108. In some embodiments, this is accomplished by an application in which the GUI calls an API to update the item characteristics. In some embodiments, this is a spring boot framework written in groovy. The input/output processor 214 directly updates the local DB. The input/output processor 214 can also operate to convert the information received into the correct format. In other words, the input/output processor 214 ensures that all data stored in the DB is converted to a normalized format.

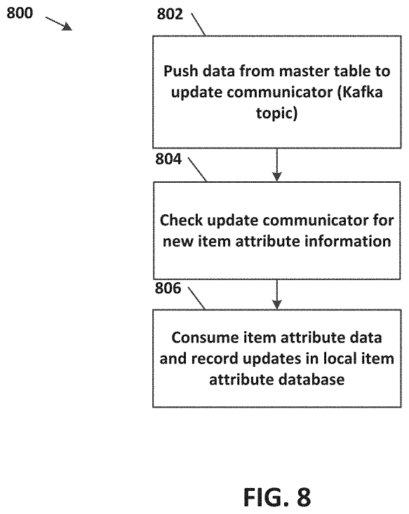

The update communicator 216 (consumer application) operates to check for updates that are made to the master table 226 of the centralized item attribute database 116. In some embodiments, a Kafka topic is utilized to receive messages identifying items with updated item attribute information. The update communicator 216 identifies which facilities contain the updated item, and fetches the updated data from the centralized item attribute database 116 to update each of the facility local item attribute databases (106, 126, 136, 146). This process is described further in relation to FIG. 8.

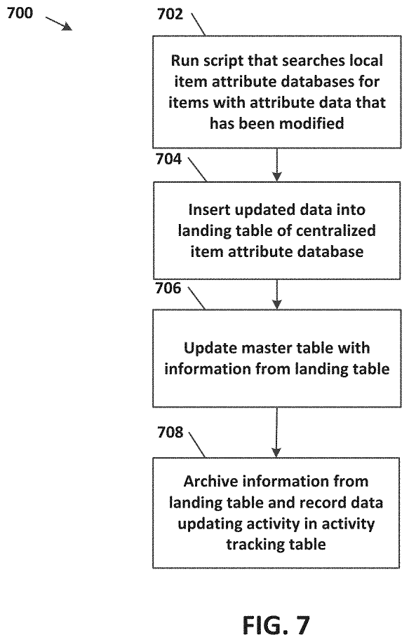

The update publisher 218 (producer application) operates to publishes updates from the local item attribute database 106 to the centralized item attribute database 116. In some embodiments, the update publisher 218 collects item attribute information by reading a local landing table populated from local stored procedure. It then sends the item attribute information utilizing a message utility, such as Apache Camel. Item attribute updates are inserted into tables of the centralized item attribute database 116. This process is described further in relation to FIG. 7.

In the example of FIG. 2, the centralized item attribute database 116 includes a landing table 222, a landing table archive 224, a master table 226, an activity tracking table 228, an application server 229, and a status code table 230. In some embodiments, the landing table archive 224 and activity tracking table 228 can be optional.

The landing table 222 is populated with data initially captured within distribution facility databases. The information received and stored in the landing table 222 includes item characteristics such as user, warehouse, and time in which the item was modified. The landing table 222 serves as a temporary storage location for newly received information before it can be processed and stored in the master table 226.

The landing table archive 224 receives data passed from the landing table 222 after a certain period of time has passed. For example, after any data has been in the landing table 222 for 2 to 14 days, it could be passed to the archive for record keeping purposes. In other examples, the information in the landing table 222 could be moved to the landing table archive 224 after 2 days, 3 days, 4 days, 5 days, 6 days, 7 days, 8 days, 9 days, or 10 days. In some embodiments, there is not a landing table archive 224 and records are deleted from the landing table 222 automatically after a given period of time such as 3 days, 5 days, 7 days, 10 days, or 14 days. Information in the landing table archive 224 could be kept for 30 days, 60 days, 6 months, 9 months, 12 months, 18 months, or two years depending on the needs of the retail enterprise.

The master table 226 keeps a record of the most up to date data regarding attributes of each item, organized by item identifier. The master table 226 is populated with information from the landing table 222 via a scheduled job executing a local stored procedure. In some embodiments, this identifier could be a SKU, a TCIN, or other unique identifier. The information in the master table 226 is used to update all of the distribution facility local item attribute databases. This table also includes the user/warehouse/time in which the item was created as well as the user/warehouse/time that it was last modified. Additional details about the functioning of the master table 226 are described in relation to FIGS. 7 and 8.

The activity tracking table 228 records events that occur within the centralized item attribute database 116. The activity tracking table 228 record insertions or updates to entries in the master table 226. Thus, the activity tracking table 228 shows whether information is new or updated and how many times a record was updated.

The application server 229 operates to run various scripts required by the centralized item attribute database 116 to move data in and out of tables. The scripts also pull in information from the update publisher 218 and push out information updates to the update communicator 216. In some embodiments, the application server 229 runs a script that pushes data out of the centralized item attribute database 116 every five minutes. The data is pulled from a select statement for any record on the master table 226 that has a status code indicating that the record has been updated.

The status code table 230 provides state code values and descriptions for the landing table 222, the master table 226, and the activity tracking table 228.

The centralized item attribute database 116 is accessible through an application programming interface (API) 234. This allows other computing services to access the item attribute information in the master table 226. Various consumers including warehouse management software services, cartonization services, and inventory services could access the item attribute information. Some services might monitor the Kafka topic for updates or they might pull information at particular times when needed.

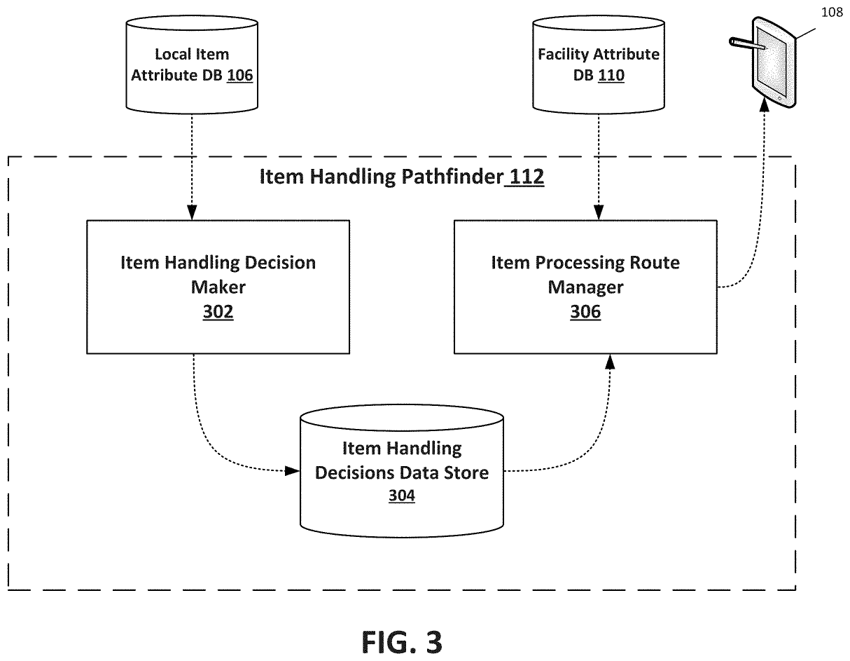

FIG. 3 illustrates a schematic diagram of an example item handling pathfinder 112. In the embodiment of FIG. 3, the item handling pathfinder 112 includes an item handling decision maker 302, an item handling decisions data store 302 and an item processing route manager 306. The item handling pathfinder 112 operates to gather pertinent information about items and facilities to determine what type of packaging the item needs to be in and what path the item can take through a distribution center. Some items require special handling and/or packaging while others can take a default path through a distribution facility. Each distribution facility can have a unique set of equipment that is used to sort and transport items. For example, some could use systems of conveyor belts to facilitate movement of items through the facility. In others, robots could move items from place to place. Yet others might rely on manual movements performed by human employees. Other considerations include the size of any opening the items might have to pass through and whether the item will be dropped for any distance. Some items may not be compatible with certain conveyor systems due to weight or dimension restrictions. It is also important to note whether particular items (such as groceries) need to be stored in certain conditions such as humidity and temperature. Some items might be stored temporarily in various locations within the facility before being shipped to their next destination.

In some embodiments, an item handling pathfinder 112 is located at each distribution facility. In some embodiments, the item handling pathfinder 112 is on a centralized server that is accessed by computing devices at each distribution facility. In the example of FIG. 3, the item handling pathfinder 112 receives information from a local item attribute database 106 and a facility attribute database 110. As described above, the local item attribute database 106 stores attributes data for items that have passed or will pass through a given distribution center. The facility attribute database 110 stores information about the distribution facility or distribution center that is pertinent to how items are handled and transported through the distribution facility.

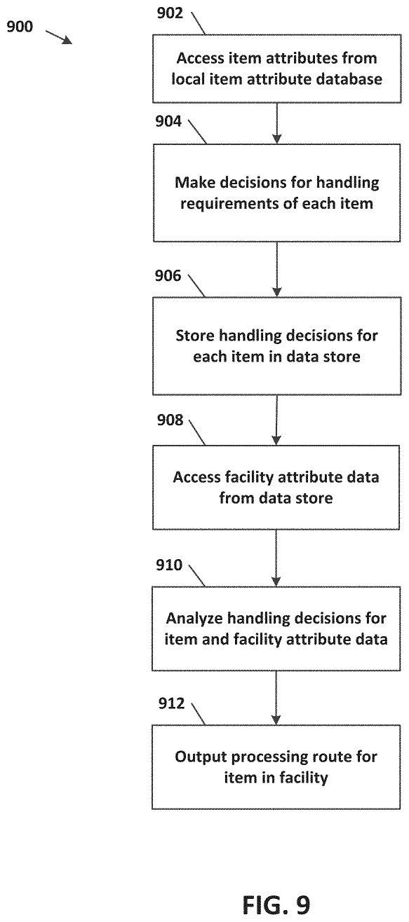

The item handling decision maker 302 receives attribute information for a given item from a local item attribute database 106. Decisions about how that item needs to be handled are made based on the item's attributes. Such attributes can include one or more of eachability, stackability, squishability, weight, height, length, width, volume, expiration date, fragility, gift wrap eligibility, packaging requirements, and storage requirements. For example, the item handling decision maker 302 may determine that a particular item can be packaged in a bag or another item might need to be packaged with extra cushioning because it is fragile. Further details regarding the functionality of the item handling decision maker 302 are provided in FIG. 9.

The item handling decisions data store 304 serves as a repository for information about how items need to be handled. In some embodiments, the item handling decisions data store 304 only stores these decisions temporarily until the item processing route manager 306 can retrieve the information for analysis. In other embodiments, the item handling decisions data store 304 can store item handling information in tables until such information is updated or deleted. The item handling information could be used for future analysis by the item processing route manager 306 or could be communicated to other facilities.

The item processing route manager 306 operates to analyze facility attribute data and item handling decisions to determine a route or path for a given item through a given distribution facility. The item processing route manager 306 receives attribute information for a given distribution facility from the facility attribute database 110. Item handling information for a given item is retrieved from the item handling decisions data store 304. This information is processed and analyzed to determine compatibility between the item's handling requirements and the facility's processing equipment and storage options. An item processing route is output for each item. Further details regarding the functionality of the item processing route manager 306 are provided in FIG. 9.

In some embodiments, the item processing route is output from the item processing route manager 306 to a user computing device 108. Here, the user computing device can display instructions to an employee of how an item is to be handled and routed. In some instances, the user computing device 108 communicates with other systems such as automated handling systems within a distribution center to ensure that the item follows its prescribed path.

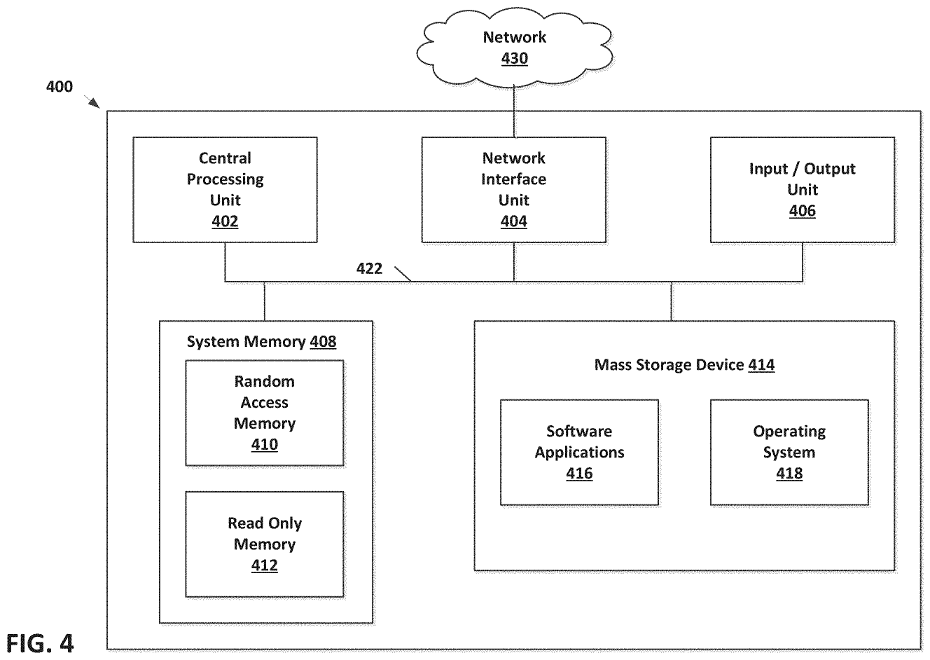

Referring now to FIG. 4, an example block diagram of a computing system 400 is shown that is useable to implement aspects of the item attribute management system 200 of FIG. 2 and the item handling pathfinder 112 of FIG. 3. In the embodiment shown, the computing system 400 includes at least one central processing unit (“CPU”) 402, a system memory 408, and a system bus 422 that couples the system memory 408 to the CPU 402. The system memory 408 includes a random access memory (“RAM”) 410 and a read-only memory (“ROM”) 412. A basic input/output system that contains the basic routines that help to transfer information between elements within the computing system 400, such as during startup, is stored in the ROM 412. The computing system 400 further includes a mass storage device 414. The mass storage device 414 is able to store software instructions and data.

The mass storage device 414 is connected to the CPU 402 through a mass storage controller (not shown) connected to the system bus 422. The mass storage device 414 and its associated computer-readable storage media provide non-volatile, non-transitory data storage for the computing system 400. Although the description of computer-readable storage media contained herein refers to a mass storage device, such as a hard disk or solid state disk, it should be appreciated by those skilled in the art that computer-readable data storage media can include any available tangible, physical device or article of manufacture from which the CPU 402 can read data and/or instructions. In certain embodiments, the computer-readable storage media comprises entirely non-transitory media.

Computer-readable storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the computing system 400.

According to various embodiments of the invention, the computing system 400 may operate in a networked environment using logical connections to remote network devices through a network 430, such as a wireless network, the Internet, or another type of network. The computing system 400 may connect to the network 430 through a network interface unit 404 connected to the system bus 422. It should be appreciated that the network interface unit 404 may also be utilized to connect to other types of networks and remote computing systems. The computing system 400 also includes an input/output controller 406 for receiving and processing input from a number of other devices, including a touch user interface display screen, or another type of input device. Similarly, the input/output controller 406 may provide output to a touch user interface display screen or other type of output device.

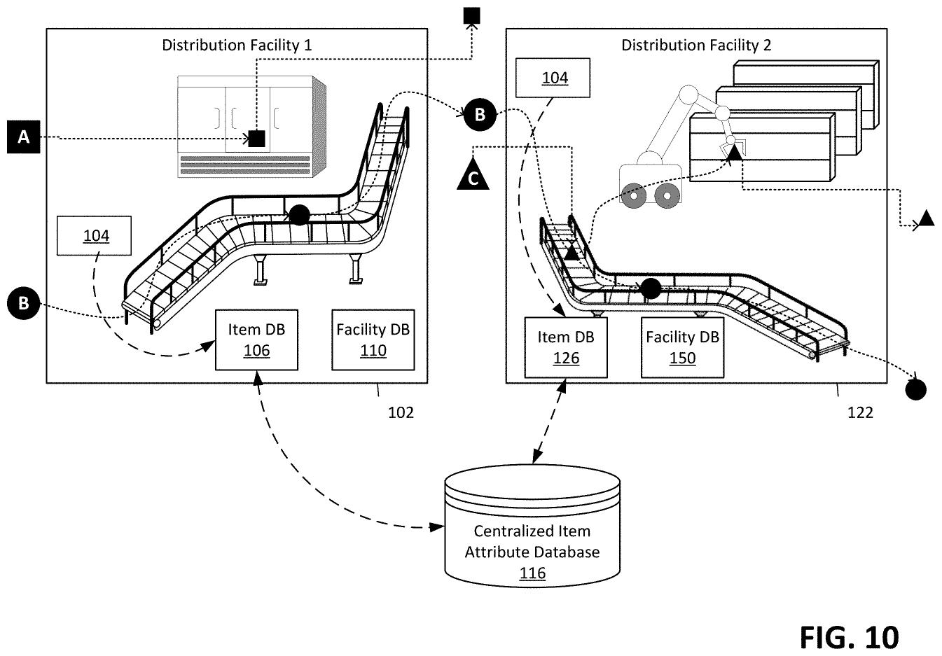

As mentioned briefly above, the mass storage device 414 and the RAM 410 of the computing system 400 can store software instructions and data. The software instructions include an operating system 418 suitable for controlling the operation of the computing system 400. The mass storage device 414 and/or the RAM 410 also store software instructions, that when executed by the CPU 402, cause the computing system 400 to provide the functionality discussed in this document. For example, the mass storage device 414 and/or the RAM 410 can store software instructions that, when executed by the CPU 402, cause the computing system 400 to display a GUI such as the GUI 212 of FIG. 2 or FIG. 10.

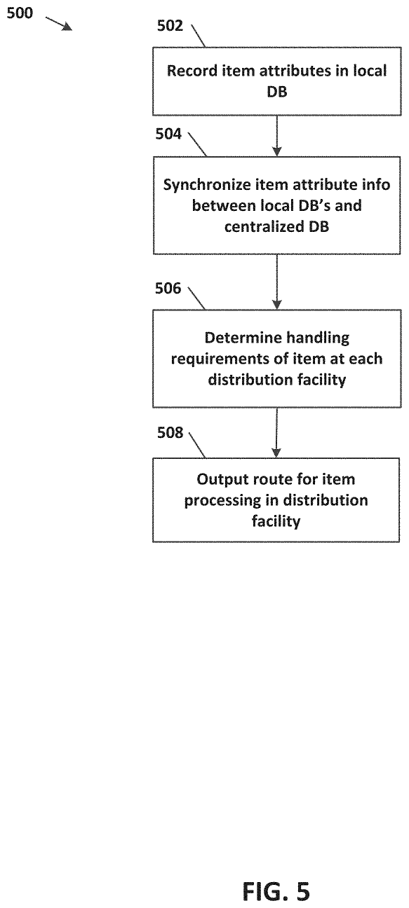

FIG. 5 is a flow chart illustrating an example method 500 of managing handling of items within a retail supply chain. In some embodiments, the method 500 is performed by the systems described in FIGS. 1-3.

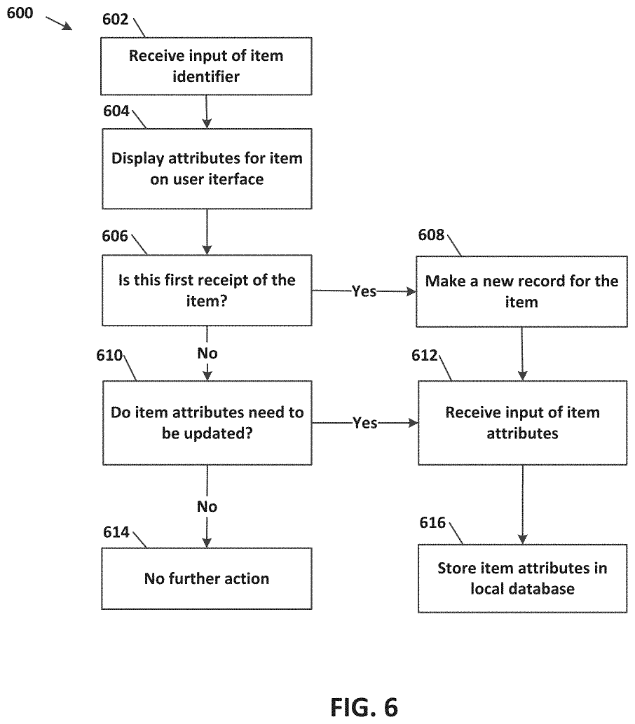

At operation 502, item attributes are captured and recorded in a local database at a distribution facility or distribution center. In the example of FIG. 1, the item attributes are obtained from an automated attribute measurement device 104, such as a CUBISCAN dimensioner, as well as a user computing device 108 which receives input from a user in the distribution facility through a GUI. The attributes for incoming items can be updates to existing items or can be a set of attributes for an item that is not in the system yet. For new items, a new record is created with a unique identifier for the new item. In some embodiments, an item attribute management server such as the distribution facility item attribute management server 202 of FIG. 2 operates to process item attribute data that is captured at the distribution facility and stores the information in a local database such as the local item attribute database 106 of FIG. 2. Additional details of this process are provided in FIG. 6.

At operation 504, item attribute information is synchronized between local item attribute database(s) and a centralized item attribute database. In the example of FIG. 1, the centralized item attribute database 116 synchronizes with the Distribution Facility 1 item attribute database 106. The centralized item attribute database 116 also synchronizes with the distribution facility 2 item attribute database 126, the distribution facility 3 item attribute database 136, and the distribution facility 4 item attribute database 146. Generally, two or more distribution facility databases will be in communication with one centralized item attribute database. In some examples, 5 or more distribution center databases synchronize with the same centralized item attribute database. In some examples there are 10 or more distribution facility databases, 20 or more distribution facility databases, or 30 or more distribution facility databases in communication with one centralized item attribute database. Communication between the centralized item attribute database 116 and the distribution facility item attribute databases 106, 126, 136, 146 can occur via wired or wireless networks, such as the Internet. Additional details of this process are provided in FIGS. 7-8

At operation 506, handling requirements for each item at a distribution center are determined. In some embodiments, this function is performed by the item handling pathfinder 112, depicted in FIGS. 1 and 3. The item handling decision maker 302 accesses item attribute data for the item from a local item attribute database 106 located at the distribution facility. As was described in operation 504, the local item attribute database 106 is synchronized with the centralized item attribute database 116 so that the item attribute data is up to date and includes any information that was entered at other distribution facilities that first received the item. The item attribute data includes information about the materials that the items are made of, item dimensions, how fragile they are, how heavy they are, whether they have special storage requirements, whether they have particular packaging requirements, and whether they have particular handling requirements. In some embodiments, decisions regarding handling of items are stored in an item handling decisions data store 304 at least until the item processing route manager 306 can access them. Additional details of this process are provided in FIG. 9.

At operation 508, a route for processing the item in the distribution facility is output. In some embodiments, this function is performed by the item processing route manager 306 of FIG. 3. In some embodiments, the route or path is determined based on item handling decisions and facility attributes for the distribution facility or distribution center where the item is being processed. Decisions about how an item is to be handled are used to determine how an item can travel through a distribution facility based on attributes of the particular facility. For example, if an item cannot be transported on a conveyer and a distribution center has multiple conveyer systems for transporting items, the route for that item would have to be altered to ensure that it is moved through the distribution facility by other means, such as by hand.

FIG. 6 is a flow diagram illustrating an example method 600 of recording item attributes in a local database. The method 600 described in FIG. 6 provides details of one example of how operation 502 of FIG. 5 could be implemented. In some embodiments, the method 600 is performed by an item attribute management system such as the item attribute management system 200 of FIG. 2. This method 600 might occur when an item is received at a distribution center for processing.

At operation 602, input of an item identifier is received. In some embodiments, the item identifier could be obtained by scanning a vendor bar code with a bar code scanner that is in communication with a computing device. Alternatively, the item could be identified by an RFID (radio frequency identification) reader that detects a signal from an RFID tag on the item. A serial number on the item could also be input with a physical or virtual keyboard on a computing device. Other means of identifying items include 2D barcodes (e.g. QR codes, SnapTags), and NFC tags. In some examples, the items are identified automatically by machines—either one at a time or in batches. In other examples, the items are identified by employees that input the identifying information into a computing device. Regardless of the method of identifying the item, an identifying number, code, or name is retrieved that is unique to that item. A common example of a unique item identifier is a SKU (stock keeping unit) code, which can include numbers and/or letters. Other examples, include global trade item numbers (GTIN), universal product codes (UPC), and international article numbers (IAN). A retailer may have their own system of identifying items, such as the Target.com Item Network (TCIN) codes, Amazon Standard Identification Number (ASIN), or Department Class Item (DPCI) codes.

At operation 604, existing attributes for the item are retrieved and displayed on a user interface. In some embodiments, item attributes can be populated in tables using information initially received from vendors. In some embodiments, the attributes are accessed from the local item attribute database 106 and communicated to the user interface 212 via the input/output processor 214. The previously recorded item attribute information is populated into a visual display on the user interface 212 which can be viewed by an individual operating a user computing device 108. The previously recorded item attribute information could have come from a vendor or from a previous first receipt process.

At operation 606, the GUI automatically informs the user if the item has been previously received at a distribution center or distribution facility within the retail supply chain. In some embodiments, the user is notified by flashing a flag on the GUI. Input of the item identifier is received from the user and checked with the local item attribute database 106 for the first distribution facility. In some embodiments, the item identifier is received from the user computing device 108 at the input/output processor 214. If the item is found to be received for the first time (no record existed for the item), the method 600 proceeds to operation 608. If the item was previously received and processed (a record is found for the item), the method 600 proceeds to operation 610. In some embodiments, if the item was previously received and processed, the method proceeds to operation 614.

At operation 608, a new record is created for the item. In some embodiments, the initial record of item characteristics will be later created in the centralized item attribute database 116 when the item is process for the first time. An employee will collect all desired item attribute information to be sent to the centralized item attribute database 116 for later distribution to all other facilities having the same item. In some embodiments, the input/output processor 214 communicates the item identifier to the local item attribute database 106 where it is recorded with any other information that was included with the item identifier in a newly created record. In some embodiments, the tag identifying the item can also include some attribute information for the item. For example, the brand name and item name might be recorded along with an identifier code for the item.

At operation 610, it is determined whether the item's attribute information needs to be updated. This can be performed manually by inspection done by an employee in the distribution center. The employee can compare the displayed attributes with those of the item to determine if attributes need to be added or changed. In some instances, prompts will appear on the user interface to alert the employee of missing information. In other instances, prompts appear on the user interface after the item's attributes are retrieved to notify the employee that item attributes need to be updated. In those instances, the employee could be prompted to analyze the item using an automated attribute measurement device 104 or request input through the user computing device 108. In some instances, an employee may be aware of an item that needs its information updated because it is not being processed correctly at a facility. If it determined that the item's attributes need to be updated, the method 600 proceeds to operation 612. If the item's attributes do not need to be updated, the method 600 proceeds to operation 614 and no further actions are taken.

At operation 612, input of item attributes is received. The item attributes can be received for the first time, can be added to existing item attribute records, or can be updated. The item attribute information is received at the input/output processor 214 from a device in communication with the distribution facility item attribute management server 202. In some embodiments, the item attribute information is recorded by an automated attribute measurement device 104. Examples of automated attribute measurement devices include scales, dimensioners, and visual scanners. In some embodiments, item attribute information is received from inputs received through a user interface 212 displayed on a user computing device 108. The attribute information can be communicated from the user computing device 108 to the input/output processor 214 by various means including a direct wired connection, a local wireless connection, a wired communication network, or a wireless communication network. The item attribute information is processed by the input/output processor 214 and the method 600 proceeds to operation 616.

At operation 616, the item attribute information is stored in a local item attribute database at the distribution facility or distribution center. In the example of FIG. 2, item attribute data is communicated via the input/output processor 214 to the local item attribute database 106 at the first distribution facility. The item attributes are recorded in tables indexed by each item's unique identifier. In some embodiments, the table includes status codes that indicate whether the attribute information for an item has been added or updated. The table can also record time stamps for events that occur with the item attribute data. In some embodiments, operations 612 and 616 are performed with a spring boot framework application written in groovy.

FIG. 7 is a flow diagram illustrating a method 700 of synchronizing item attribute data from a local database to a centralized item attribute database. New or updated item attribute data captured at a distribution facility or distribution center is communicated to the centralized database.

At operation 702, a shell script is ran by a scheduler that executes a local stored procedure on the facilities database and searches local item attribute databases for items with attribute data that has been modified or added and have already been first receipted and not modified simply by the external host application. The modifications can be made to any number of tables that capture item characteristics. The select statement is written leveraging “union alls” so that it pulls the most recent modification timestamp in any of the tables in which the last updated source is not Host. The select statement also records the warehouse name. Thus, three fields (user, warehouse, last modified time) are also documented for each item that has been updated. Finally, this information is inserted within a local landing table within the facilities warehouse management systems database with a flag indicating to the producer application that new data is ready to be sent to the centralized database.

At operation 704, the updated item data is inserted into a landing table of a centralized item attribute database. In some embodiments, updated item attribute information is inserted into the landing table 222 of the centralized item attribute database 116 of FIG. 2. In some embodiments, a select statement stores the updated data in Camel memory before inserting into the landing table 222. Inserted records are given a default value of “10” for “loaded.” This indicates to a stored procedure to update the master table 226.

At operation 706, a master table within the centralized item attribute database is updated with the item attribute information from the landing table. In some embodiments, the master table 226 of the centralized item attribute database 116 is updated from the landing table 222. In some embodiments, a SQL Package executes on a regular schedule to update all records to process to a status of “20” for “in process.” The SQL package inserts or updates an existing record within the item characteristics for that item within the master table with a status of “10” for “loaded.” An insert is only performed if the item does not yet exist, so that there is only one record for each unique item identifier. This status value helps identify for the producer all items which have changed, so that it can later create a list of items and make a distinct message in the Kafka topic to inform all consumers the change in items. The master table 226 only holds one record per item identifier in a table so that the most up to date item information is the only information stored. This table includes the user/warehouse/time in which an item was created as well as the user/warehouse/time that it was last modified.

After achieving the status of “20,” if the package experiences an unexpected exception for any particular record, it will update that specific record to a status of “35” for “Errored at Master table.” If the record is processed successfully, it will achieve a status of “30” for “processed.”

At operation 708, information from the landing table is recorded in an archive table, such as the landing table archive 224. In some embodiments, updating activity is recorded in an activity tracking table, such as the activity tracking table 228. In some embodiments, there is not an archiving table. To optimize the database performance, an SQL package executes daily to identify any records that have the status “30” for “processed” that are older than 7 days. That data is inserted into the landing table archive 224. Data in the landing table archive 224 can be stored for up to a year. These records are updated to a status of “40” for “Archived.” If the records encounter an error during archiving, they will be given a status of “45” for “Errored at Archived” within the master table 226.

FIG. 8 is a flow diagram illustrating a method of synchronizing item attribute data from a centralized item attribute database to a plurality of local item attribute databases located at a plurality of distribution facilities. Updated item attribute data is pushed out to all distribution facility item attribute databases. This ensures that all distribution centers have up to date item attribute information and eliminates the need to record item attributes at multiple distribution facilities for the same new items.

At operation 802, data is pushed from the master table in the centralized item attribute database to an update communicator. This is accomplished when a producer application creates a message for each updated item within a Kafka topic, identified by the status on the centralized master table 226. After the record is sent to the Kafka topic (update communicator 216), the script updates the status code to “30” for “Sent to Kafka” on the master table 226.

In some embodiments, the shell script runs every 5 minutes on the application server 229 that pulls data from a select statement for any record on the master table 226 that has a push state code of “10” (“loaded”). Other time frequencies are possible such as every 2 minutes, every 3 minutes, every 6 minutes, every 8 minutes, every 10 minutes, and every 15 minutes. In some embodiments, this data is sent as a string to a Kafka topic using a comma separator. After the record is sent to the Kafka topic (update communicator 216), the script updates the status code to “30” for “Sent to Kafka” on the master table 226. In some embodiments, XML could be used to move data to the update communicator 216 instead of comma separators. In some embodiments, the event of moving data to the Kafka topic can be recorded in the activity tracking table 228.

At operation 804, the update communicator 216 is checked for new item attribute information. In some embodiments, this is accomplished by a consumer application with a spring boot framework written in groovy. This application does 3 parts. It will consume the Kafka topic message containing the identifier (SKU) of the item which has been updated. The application will then call an API to an external host to understand which of the facilities have this item. It will call an API which will collect all the item attribute information stored within the master table on the centralized database. Lastly, it will then insert the item attribute information for all appropriate sites within the local warehouse management system's database. This application will continually monitoring the Kafka topic for updates.

At operation 806, the item attribute data is consumed and updates are recorded in local item attribute databases. In some embodiments, this is accomplished with an additional local stored procedure scheduled by a Linux shell script. The new data is pulled into a local item attribute database 106 at each appropriate distribution facility. A check is performed to determine if the updated item attribute data is for an item that is listed in a table in that distribution center's local item attribute database 106. Updates to item data are only performed for those items that are already in the local database and are not from an originally outbound message from the same warehouse. In other words, an update is not necessary if the new information came from that same distribution facility. Not every distribution facility will encounter a given item if the item is not present or legal for that location.

For distribution centers that need updates to an item's attribute data, tables are updated with the new information. In some embodiments, four separate update statements are performed for each of four item tables in which the item characteristics can be found for the particular item. In some embodiments, greater or fewer tables are used.

In some embodiments, distribution facilities can manage item attribute data in ways that are not dependent upon the timing of item attribute data updates as described above. For example, when a distribution facility is designated to start receiving an item that has been in the supply chain, but not ever circulated through that distribution facility, the distribution facility needs to access item attribute data for that item.

The local item attribute database 106 at that distribution facility can automatically obtain the item attribute data using the same producer application, the update publisher 218. This application will update the item status on the master centralized database and thus create a message in the Kafka topic. As a result, the consumer will consume that message and follow the same process as any item update. However, this time it will find the new facility as a valid facility to send the item attributes to the facility's local item attribute database 106. As a result, all appropriate records for that item in the local item attribute database 106 are updated with the latest information from the centralized database 116.

In some embodiments, when a distribution facility will no longer be handling a particular item and wants to remove that item's attribute data from its local item attribute database 106, a script can run to eliminate that item record from the local item attribute database 106.

FIG. 9 shows a flow diagram illustrating a method 900 of determining a handling path through a distribution facility or distribution center. In some embodiments, the method 900 provides more details of operations 506 and 508 of the method 500 described generally in FIG. 5. In some embodiments, the method 900 is performed by the item handling pathfinder 112 of FIG. 3.

At operation 902, item attribute data is accessed from local item attribute databases. For example, in a first distribution facility 102, item attribute data is retrieved from the local item attribute database 106 at Distribution Facility 1. Attributes that are pertinent to the item handling pathfinder 112 can include eachability, nestability, squishability, dimensions, weight, fragility, and packaging options. In some embodiments, the item attribute data is consumed by the item handling decision maker 302.

At operation 904, decisions are made for how each item needs to be handled. Based on the item attribute data for each item, the item handling decision maker 302 outputs decisions regarding the handling requirements of each item. Examples of handling requirements include packaging requirements, storage condition requirements, and types of equipment that the item can be handled with.

At operation 906, the handling decisions for each item are stored in a data store. In some embodiments, the item handling decisions output by the item handling decision maker 302 are stored in the item handling decisions data store 304 of FIG. 3. The handling decisions can be stored in tables that are indexed by item identifier (e.g. SKU, TCIN, etc.)

At operation 908, facility attribute data is accessed from a data store. In some embodiments, the facility attribute data is data for a particular distribution facility that is accessed from a facility attribute database 110. The facility attribute database 110 could be housed at the distribution facility or could be accessed from a centralized location. In some embodiments, the facility attribute data is consumed by the item processing route manager 306. Examples of facility attribute data that may be useful for making processing route decisions include one or more storage area types, availability of storage, size of openings in equipment and between rooms; types of conveyors utilized, weight limits of equipment, types of automated equipment utilized, and availability of temperature and/or humidity controlled storage.

At operation 910, handling decisions for items and facility attribute data are analyzed. In some embodiments, the item processing route manager 306 analyzes data from the facility attribute database 110 and item handling decisions from the item handling decisions data store 304 to determine the best path for an item to take through a distribution facility.

At operation 912, a processing route is output for each item in a facility. In some embodiments, the item processing route manager 306 outputs processing routes for each item that is received at a distribution facility or distribution center. The route information can be output to a user computing device 108 where it is displayed. An employee could view the routing information in order to take steps to ensure that a given item is processed correctly. In some embodiments, the processing route is output to other computing devices that are in communication with automated equipment so that particular items can be routed through different paths within a facility.

In some embodiments, the process repeats operations 908, 910, and 912 again for additional distribution facilities. A first set of routing information could be output for a first item at a first distribution location, a second set of routing information could be output for the first item at a second distribution location, and a third set of routing could be output for a second item at the second distribution location. When an item of a first type is received for the first time at a first distribution facility and its item attributes are captured and saved to the centralized item attribute database 116, that item attribute information becomes available to other distribution facilities. When another item of the first type (sharing the same unique item identifier) is received for the first time at a second distribution facility, the item attributes for that item can be accessed from the local item attribute database at the second distribution facility because that local item database would be updated with information received from the centralized item attribute database 116.

Thus, the same item attribute information does not need to be captured more than once within the same retail enterprise supply chain. This provides advantages not only in reducing labor costs, but also reduces the computational load on the systems used in the supply chain to manage item handling. Saving time accessing item attribute information can be particularly advantageous for processes that need to be completed shortly after an item is received at a distribution facility, such as determining how that item is to be handled within the distribution facility.

FIG. 10 illustrates a simplified example of a retail enterprise having two distribution facilities (102, 122) that handle three items (A, B, C). Both distribution facilities have an automated attribute measurement device 104 that captures attribute data for items coming into the distribution facility. Also shown are an item attribute database 106, 126 and a facility attribute database 110, 150 for each distribution facility. In some embodiments, the item attribute databases and facility attribute databases can be one and the same. This diagram illustrates how different items are handled in facilities having different equipment and how synchronizing item attribute data between a centralized item attribute database 116 and local item attribute databases 106, 126 can provide efficiencies in item handling.

In the example shown in FIG. 10, item A is received at a first distribution facility 102. Item A has not been received and processed by any distribution facilities within the supply chain. This can be determined by obtaining a unique item identifier associated with Item A and checking the local item attribute database 106 for a record matching that unique item identifier. Because there is not already a record for Item A, the automated attribute measurement device 104 captures item attributes for Item A and updates the correct item dimensions to the item record that is stored in a table of the local item attribute database 106 at the first distribution facility. The item attribute data for Item A is then synchronized with the centralized item attribute database 116 (as described above in FIG. 7). The item handling pathfinder 112 (not shown) utilizes the item attribute data for Item A stored in the local item attribute database 106 with the facility attribute data for the first distribution facility 102 stored in the facility attribute database 110 to determine a processing route for Item A through the first distribution facility. In this example, Item A is temporarily stored in a refrigerator until it is ultimately shipped to its final destination. The final destination could be a customer's address, a retail store, or another distribution facility.

Item B is also received at the first distribution facility 102. Item B's item identifier is checked with the local item attribute database 106 and no record is found. In some embodiments, the item attributes for Item B can be captured with the automated attribute measurement device 104 and stored in the local item attribute database 106. Within an hour of the item being created within the new facility, item B's attribute information is synchronized with the centralized item attribute database 116. In some embodiments, the synchronization may occur in less than an hour, less than two hours, or less than four hours. The item handling pathfinder 112 determines a processing route for Item B through the first distribution facility. Item B has different attributes from Item A and requires different handling, so Item B is given a different processing route for the first distribution facility 102. In this example, Item B travels through the first distribution facility 102 via a conveyor and then is immediately shipped off to the second distribution facility 122.

After Item B arrives at the second distribution center 122, its item identifier is checked against the local item attribute database 126 at the second distribution center 122. The item attribute information for Item B has been communicated from the centralized item attribute database 116 to the local item attribute database 126 so a valid record is found for Item B. The item attribute information for Item B is accessed from the local item attribute database 126 and the facility attribute information for Distribution Facility 2 (122) is accessed from the facility attribute database 150 by the item handling pathfinder 112. Thus, the handling requirements for Item B and the handling route for Item B in Distribution Facility 2 can be determined without having to capture Item B's attributes when it arrives at Distribution Facility 2. This enables the item handling pathfinder 112 to perform its computations more quickly, which in turn results in quicker processing of Item B at the second distribution facility 122. Overall, the inbound item receiving process is more productive as a result. In the example of FIG. 10, Item B is processed with a route that takes it through the facility on a conveyer before it is shipped out of the second distribution facility 122. Because the second distribution facility 122 has different attributes from the first distribution facility 102, Item B is handled differently at each facility.

Item C is received at the second distribution center 122 for the first time. Item C's identifier is checked against the local item attribute database 126 and no record is found. Upon gathering the item attribute data for Item C using the automated attribute measurement device 104, the item attribute data is stored in the local item attribute database 126 and is synchronized to the centralized item attribute database 116. The item handling pathfinder 112 accesses the item attribute database 126 and facility attribute database 150 to gather the item attributes and facility attributes to determine a set of routing information for Item C in the second distribution facility 122. In the example of FIG. 10, the route for Item C is different from that of Item B and a robot is utilized to transfer Item C from the conveyor to a storage shelf for temporary storage before Item C is shipped out from the second distribution facility 122.

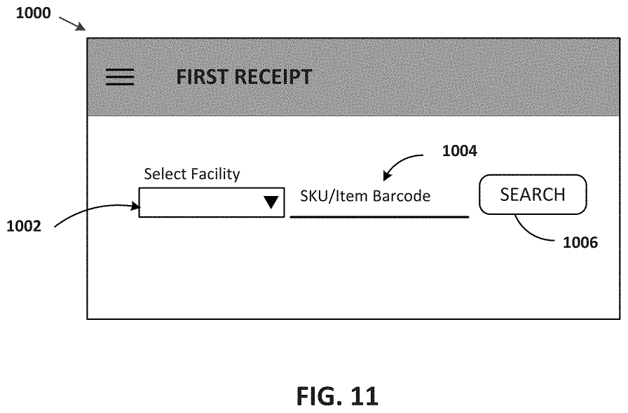

FIGS. 11-15 illustrate different views of an example graphical user interface 1000. In some embodiments, the graphical user interface 1000 provides a simplified, streamlined interface for inputting item attribute information into a warehouse management system and other computing systems that are involved in supply chain management. In some embodiments, the GUI 1000 includes a plurality of fields in which item attribute information can be input. The fields can be displayed on one single page or view to reduce the number of interactions required from a user. In some embodiments, the fields primarily consist of drop-down menus or other selectors that limit the input options to those that are applicable to the retail enterprise. In some embodiments, the fields and available selectors that are displayed are unique to the distribution location based on the facility attributes and items that are expected to be processed at that location. In some instances, when one input is received at a first field, a second field will appear that is dependent upon the first field.

When an item is being processed that is already associated with a record in the local item attribute database 106, the GUI 1000 can display the item attribute information. The item attribute information for that item can be edited and updated by a user if it is wrong or outdated.

In some embodiments, some of the fields can be prepopulated with information received from the vendor. Corrections to this information can be made using the GUI 1000.

FIG. 11 illustrates a first view of the GUI 1000. A facility selector 1002, item number field 1004 and search button 1006 are displayed. The facility selector 1002 is shown as a drop down menu, but other methods of selecting a facility are possible. The facility could be a retail store, a distribution center, a warehouse, or any other facility within a retail enterprise where items might be processed or stored. In some embodiments, when a user is logged in the facility selector 1002 will only show the facility in which the user is working.

The item number field 1004 is shown with the prompt “SKU/Item Barcode.” A user could type in a number or a number could populate the field from a barcode scanner. Once the requested information is entered, a user can select the search button 1006 to proceed with the search. The search retrieves item attributes for the selected item. In some embodiments, the GUI 1000 makes an API call to a local item attribute database 106

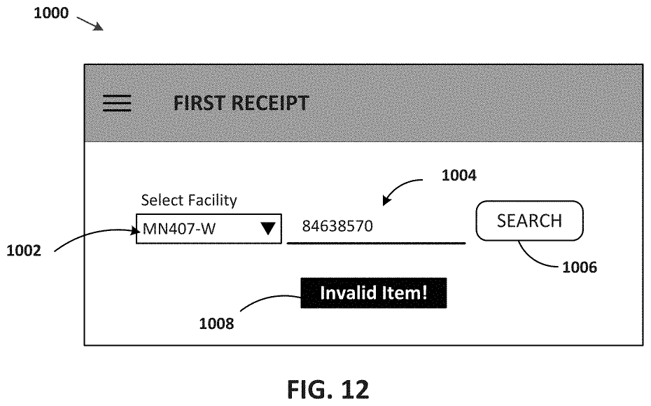

FIG. 12 shows the GUI 1000 after an invalid item number has been entered into the item number field 1004. An alert 1008 is displayed to indicate the error. This could appear because an item number that does not exist is entered or an item number is not available at the selected facility.

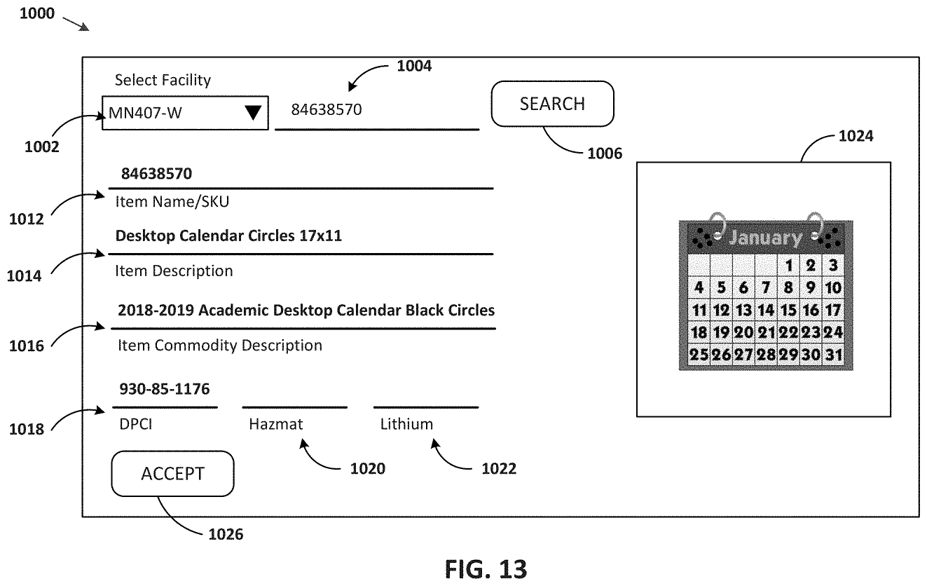

FIG. 13 shows another view of the GUI 1000 after the search has proceeded with a valid item number. Attribute information for the entered item is displayed including item name/SKU 1012, item description 1014, item commodity description 1016, DPCI 1018, hazmat status 1020, lithium status 1022, and a graphical representation 1024 of the item. In the event that the selected item has not been through the intake process, the item attribute management server for the facility may populate some attributes for the item with available information such as a SKU and item description. The displayed attributes help a user confirm that the correct item is being displayed. In some embodiments, the user cannot edit any of the information in the fields on this screen. To proceed with the displayed item, the user selects the “Accept” button 1026.

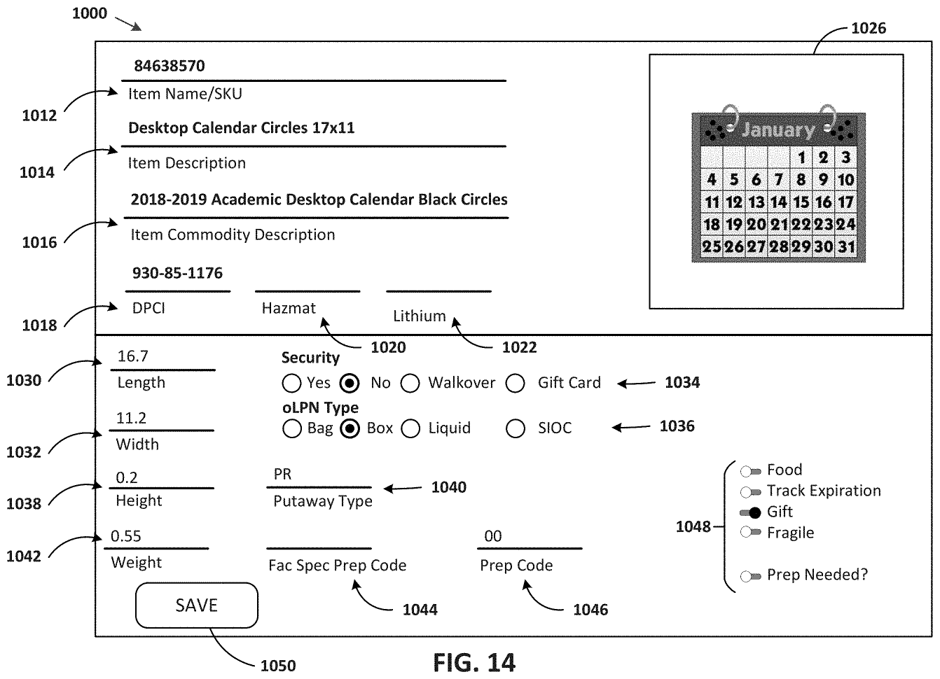

FIG. 14 shows the GUI 1000 after the “Accept” button 1026 was selected. Additional fields and item attribute information are displayed. In the example of FIG. 14, the additional information includes length 1030, width 1032, security requirements 1034, oLPN type 1036, height 1038, putaway type 1040, weight 1042, facility specific prep code 1044, and prep code 1046. There is also a set of toggles 1048 to indicate other attributes applicable to the item. In this example those attributes include “food,” “track expiration,” “gift,” “fragile,” and “prep needed?”. In the example of FIG. 14, the “gift” toggle is turned on and the other toggles are turned off.

The security requirements 1034 and putaway type 1040 are item fields that determine how each item is processed within a facility. Items having particular security and putaway types are housed within a separate area of a facility. For example, a “walkover” item such as a basketball or umbrella would have difficulty being processed by automatic material handling equipment and would therefore be separated from other items for processing. The oLPN type 1036 determines which type of container an item should be placed in for shipment. In the example of FIG. 14, “box” has been selected as the oLPN type 1036. The container type determines which type of container to place an item into during prep, prior to being cartonized into the oLPN type of container. The facility specific prep code 1044 informs employees how to prepare an item for shipment. For example, adding bubble wrap or a polymer bag might be additional steps required to prepare an item for shipping. The prep code 1046 is utilized to inform reporting teams at a retailer headquarters of how much prep effort is required for a particular item from the perspective of financial and labor costs.

In this view, a user can edit and add item attributes. In some embodiments, only a subset of the item attributes can be edited. For example, the length 1030, width 1032, height 1038, and weight 1042 may be automatically populated from existing information received from, for example, an automatic dimensioner. Other fields could be edited and updated by the user. In some embodiments, some fields will dynamically update as information is entered into other fields. For example, if an item is indicated as being food at the toggles 1048, the toggle for “track expiration” within the set of toggles will be automatically activated as well. Additionally, the putaway type 1040 will be updated to “expiration tracked.”

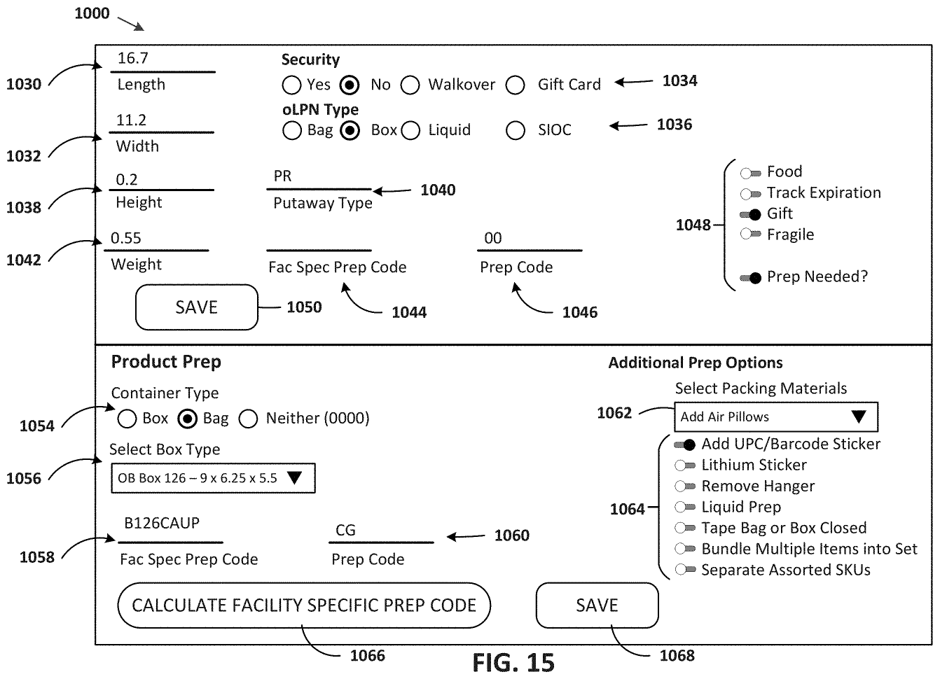

Once the item attributes are edited to the user's liking he or she can select the “Save” button 1050 to save the information. If the user selects the “Prep Needed?” toggle from the set of toggles 1048, more fields will populate in the GUI 1000 as shown in FIG. 15.

FIG. 15 shows a view of the GUI 1000 displaying additional item attributes fields relevant to product prep. In this example, additional fields relating to product preparation include container type 1054, box type 1056, facility specific prep code 1058, and prep code 1060. In some embodiments, additional prep options can be displayed such as a packing materials selector 1062 and a set of toggles 1064 indicating different packaging instructions. A calculation button 1066 for determining the facility specific prep code helps a user to not have to memorize or look up the codes. The save button 1068 can be selected when the desired attributes are entered into the GUI 1000. The updated item attribute information is then sent to the centralized item attribute database 116.

Selections of these attributes help to ensure that items are properly packaged in order to be shipped without being damaged. The GUI 1000 is designed to be very user friendly and limits the amount of information that a user has to remember or look up. Additionally, because there are very few text entry fields, users are provided with a finite amount of options that the user knows will be valid when selected. Other systems rely on a lot of freeform text boxes which can result in inconsistent or incorrect entries. The use of toggles, radial buttons, and drop down menus makes the process easier and less error-prone for users.

Previously, redundant item intake processes were required to acquire item attribute data because multiple facilities would receive the same item, but there was no communication between the distribution facilities. The present disclosure describes methods and systems that provide a centralized repository of item attribute data that is synchronized with distribution location databases so that the most up to date item attribute data is available at all of the distribution locations. This results in a reduction of labor costs because employees are not repeating the intake process.

Further, this method provides computational efficiencies in that computing devices do not have to process item attribute data more than once. Other efficiencies are obtained from the use of a streamlined graphical user interface. This GUI allows for input and editing of item attribute data using a single screen. This reduces the number of interactions and inputs required to enter all of the attribute data. Drop down menus and the like provide other efficiencies in that they provide a finite number of options to select from, thus avoiding problems with inconsistent inputs.

The description and illustration of one or more embodiments provided in this application are not intended to limit or restrict the scope of the invention as claimed in any way. The embodiments, examples, and details provided in this application are considered sufficient to convey possession and enable others to make and use the best mode of claimed invention. The claimed invention should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the general inventive concept embodied in this application that do not depart from the broader scope of the claimed invention.

1. A method of managing item handling within a retail enterprise supply chain including a plurality of distribution locations, the method comprising:
capturing item attributes of a first item at a first distribution facility;
communicating the item attributes of the first item to a centralized item attribute database for storage; and
generating a first set of routing information for the first item and first distribution facility based on the item attributes of the first item and facility attributes of the first distribution facility.

2. The method of claim 1, further comprising generating a second set of routing information for the first item and a second distribution facility, the second distribution facility having different facility attributes than the first distribution facility.

3. The method of claim 1, further comprising generating a second set of routing information based on the receipt of the first item at a second distribution facility without requiring capture of item attributes of the first item at the second distribution facility.

4. The method of claim 1, wherein at least some of the item attributes are captured using a dimensioner in communication with a computing device.

5. The method of claim 1, wherein at least some of the item attributes are captured by receiving input through a graphical user interface displayed on a computing device.

6. The method of claim 1, further comprising receiving a first identifier associated with the first item; locating a record matching the first identifier; and updating item attribute information for the first item.

7. The method of claim 1, further comprising receiving a first identifier associated with the first item; creating a record for the first item; and recording item attribute information for the first item in a table with the first identifier.

8. The method of claim 1, wherein the attributes of the first item are stored in a local item attribute database at the first distribution facility.

9. The method of claim 8, further comprising synchronizing the attributes of the first item between the centralized item attribute database and a plurality of local item attribute databases at a plurality of distribution facilities.

10. The method of claim 9, wherein the synchronization is accomplished by:
communicating the item attribute data stored in the master table for the first item from the centralized item attribute database to an update communicator;
checking the update communicator for updates to item attribute data;
retrieving updated item attribute data including item attribute data for the first item from update communicator; and
storing the attribute data for the first item in the local item attribute database at the second distribution facility.

11. The method of claim 10, further comprising:
recording data updating activity in an activity tracking data within the centralized item attribute database; and
archiving information from the landing table to a landing table archive within the centralized item attribute database after 2 to 14 days.

12. The method of claim 1, wherein the attributes of the first item are communicated to a centralized item attribute database by:
searching local item attribute databases for item records that have been modified;
inserting updated item attribute data into a landing table of the centralized item attribute database; and
updating a master table of the centralized item attribute database with item attribute data from the landing table.

13. The method of claim 1, wherein the first set of routing information is generated by:
accessing the item attributes of the first item;
determining handling requirements for the first item based on the item attributes;
accessing facility attributes of the first distribution facility;
analyzing the item attributes of the first item and the facility attributes of the first distribution facility to determine the first set of routing information; and
outputting the first set of routing information to a computing device.

14. A system for managing handling of items within a retail enterprise supply chain including a plurality of distribution facilities, the system comprising:
a centralized item attribute database for the retail enterprise supply chain;
a plurality of local item attribute databases at each of the plurality of distribution facilities;
a facility attribute database comprising facility attribute data for the plurality of distribution facilities;
an item attribute management system executing on a computing device, the item attribute management system comprising a processing device and a memory device comprising instructions that, when executed by the processing device, cause the item attribute management system to:
receive input of item identifiers associated with items at a first distribution facility;
receive item attribute data for the items;
store the item attribute data in a local item attribute database at the first distribution facility;
retrieve the item attribute data from the local item attribute database;
insert the item attribute data into a landing table of a centralized item attribute database;
update a master table of the centralized item attribute database with the item attribute data from the landing table;
communicate the item attribute data stored in the master table from the centralized item attribute database to an update communicator;
retrieve the item attribute data from update communicator; and
store the item attribute data in a local item attribute database at a second distribution facility; and
an item handling pathfinder executing on a computing device, the item handling pathfinder comprising a processing device and a memory device comprising instruction that, when executed by the processing device, cause the item handling pathfinder to:
access item attribute data for a first item;
determine handling requirements for the first item based on the item attribute data;
access facility attribute data for the first distribution facility;
analyze the item attribute data for the first item and the facility attribute data for the first distribution facility to determine a first set of routing information; and
output the first set of routing information to a computing device at the first distribution facility.

15. The system of claim 14, wherein the pathfinder is further configured to:
access handling requirements for the first item;
access facility attributes of a second distribution facility;
analyze the item attribute data of the first item and the facility attribute data of the second distribution facility to determine a second set of routing information; and
output the second set of routing information to a computing device at the second distribution facility.

16. The system of claim 14, wherein item attribute data is received at the item attribute management system from an automated attribute measurement device.

17. The system of claim 14, wherein the item attribute management system further comprises a graphical user interface configured to display fields on a computing device for receiving input of item attribute data.

18. The system of claim 14, wherein the item attribute management system further comprises an application programming interface in communication with the master table of the centralized item attribute database, the application programming interface operating to provide item attribute data to external computing services within the retail enterprise supply chain.

19. The system of claim 14, wherein facility attribute data comprises one or more of storage area types, availability of storage, types of conveyors utilized, size of openings, weight limits of equipment, and types of automated equipment utilized.

20. The system of claim 14, wherein the item attribute data comprises one or more of eachability, stackability, squishability, weight, height, length, width, volume, expiration date, fragility, gift wrap eligibility, packaging requirements, and storage requirements.

21. A non-transitory computer-readable storage medium comprising computer-executable instructions which, when executed by a computing system, cause the computing system to perform a method of managing item attribute data, the method comprising:
capturing attributes of a first item at a first distribution facility by:
receiving input of item identifier;
ascertaining that first item is being received for the first time in the retail enterprise supply chain;
creating a new item record for the first item;
receiving input of item attributes for the first item; and
storing the item attributes for the first item in a local database at the first distribution facility;
communicating the attributes of the first item to a centralized item attribute database for storage by:
searching local item attribute databases for item records that have been modified;
inserting updated item attribute data into landing table of centralized item attribute database;
updating a master table of a centralized item attribute database with item attribute data from landing table;
recording data updating activity in an activity tracking data within the centralized item attribute database; and
optionally archiving information from the landing table to an archive table within the centralized item attribute database after 7 days;
communicating the item attribute data for the first item to a second distribution facility by:
communicating the item attribute data stored in the master table for the first item from the centralized item attribute database to an update communicator;
checking the update communicator for updates to item attribute data;
retrieving updated item attribute data including item attribute data for the first item from update communicator; and
storing the attribute data for the first item in the local item attribute database at the second distribution facility
generating a first set of routing information for the first item and first distribution facility by:
accessing the item attributes of the first item;
determining handling requirements for the first item based on the item attributes of the first item;
accessing facility attributes of the first distribution facility;
analyzing the item attributes of the first item and the facility attributes of the first distribution facility to determine the first set of routing information; and
outputting the first set of routing information to a computing device;
generating a second set of routing information for the first item and second distribution facility by:
accessing the handling requirements for the first item;
accessing facility attributes of the first distribution facility;
analyzing the item attributes of the first item and the facility attributes of the first distribution facility to determine the first set of routing information; and
outputting the second set of routing information to a computing device.

22. The non-transitory computer-readable storage medium of claim 21, wherein the second set of routing information is generated upon receipt of the first item at the second distribution facility and does not require capturing attributes of the first item at the second distribution facility.
